(19) United States
(12) Patent Application Publication
(10) Pub. No.: US 2005/0205482 A1
(43) Pub. Date: Sep. 22, 2005

(54) Water filter for clothes washing machine

(76) Inventor: William R. Gladney, Columbus, OH (US)

Correspondence Address: Neal T. Hauschild, 4310 Sunbury Rd., Galena, OH, 43021, US

(21) Appl. No.: 10/800,996

(22) Filed: Mar. 16, 2004

(51) Int. Cl. B01D 27/02

(52) U.S. Cl. 210/264; 210/282

(57) ABSTRACT

The present invention provides a water filtration apparatus for mounting on the exposed exterior surfaces of a clothes washing machine to provide filtered water to the interior of a clothes washing machine cabinet. The apparatus may be mounted on the exposed or visible surfaces of the clothes washing machine for ease of installation, monitoring, and filter replacement. A readily replaceable filter cartridge is also provided.

### CROSS REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

The present invention relates to a water filtration apparatus for incorporation within a clothes washing machine. More specifically, the present invention is an apparatus with a readily replaceable filter cartridge for providing filtered water to a clothes washing machine so that filtered hot and cold water is available for the clothes washing machine water dispensing unit.

Water intended for human consumption is expected to be either free of harmful constituents or contain concentrations of such constituents that are below harmful levels. To provide potable water for use in homes and businesses, municipalities utilize industrial scale processes in an effort to eliminate or reduce harmful constituents present in water drawn from large, naturally occurring water sources. Frequently though, additives that are not harmful for consumption or minerals not deemed to be harmful for human consumption can cause deterioration of clothes during the wash process.

The consistency and efficiency of treatment by municipalities may vary due to numerous factors such as heavy rainfall, equipment failures, and usage levels. Water obtained directly from a natural source may also become suspect depending upon environmental conditions near the source. For examples, wells and springs can be contaminated due to rain water run-off washing a contaminant into the source. Furthermore, these sources may be high in minerals that can cause color loss, mineral deposits, stains, etc. on clothes.

Various water filtration devices have been developed. Such devices range from those located at the point-of-use (e.g. the spigot of a kitchen sink, gravity-flow dispensers such as dispensers, and low-pressure dispensers such as sports bottles) to the generally bulkier point-of-entry units hidden from view within the plumbing of a home or office. Many of these devices use activated charcoal in at least one stage of the filtration process. Activated charcoal helps to remove strong odors and tastes from water. More specifically, activated charcoal can remove chlorine and sediment from water.

Generally, the currently available devices for water filtration on a non-industrial scale may be divided into two categories: point-of-use and point-of-entry filtration systems. Typically, a point-of-entry system provides for the filtration of water at the point where the supply enters a dwelling or area of use. The point-of-entry system filters the entire water supply, and filtered water is then distributed to various points of use after filtration. As an example, a point-of-entry system may be located in the basement, cellar, or other location hidden from plain view. In contrast to point-of-use systems, point-of-entry systems may be larger in physical size because of the volumetric rate of water that must be filtered in order to supply filtered water to all of the points-of-use within a dwelling or other use area. Furthermore, a point of entry system may be less efficient because water may be filtered unnecessarily. For example, the homeowner may desire filtered water for the kitchen and bathrooms but not for outdoor spigots or laundry. In addition, an individual may desire to remove specific items from the water supply for laundry to prevent undesired effects unfiltered water may have on clothing.

Point-of-use systems, on the other hand, provide for filtration of the water at the point of consumption or application. For example, point-of-use systems may be located at the kitchen sink ensuring that potable, filtered water is used in cooking and kitchen cleaning. Such systems may consist of a device, visible to the user, attached to the end of a faucet. Other systems may consist of a filter located within a pitcher such that water placed into the top of the pitcher filters water through to a bottom compartment for storage until consumption. Still other systems, due to size and bulkiness, may be located under a sink or within a nearby kitchen cabinet.

Point-of-use water filtration systems for clothes washing machines have also been developed. Washing machines having separate washing and dehydrating tubs for respective washing of fabric articles on the one hand and for rinsing and dehydrating the fabric articles on the other hand are well known. When using washing machines of this type in geographical areas where the water supply is contaminated or contains impurities, the washed articles may become discolored by iron oxide powder or other foreign matter contained in the water supply when the contaminated water is supplied to the dehydrating tub for rinsing the washed fabric articles. Therefore, washing machines intended for use in those geographic areas where the water supply is impure must be provided with a filter for filtering the water supplied to the washing and dehydrating tubs. Normally, water filters are provided structurally independently of the washing machine to accomplish such functions. However, such conventional filter devices are more troublesome to the user since the filter device must be manually coupled to the washing machine via hoses or other like conduit means.

To solve the above-mentioned disadvantages, it has recently been proposed to provide a washing machine having an operation control console that internally includes a filter device at its rear portion. Such a washing machine solves the disadvantages with respect to washing machines having structurally independent filter devices but is less than desirable since different operation console shapes must be provided for each different type and/or style of washing machine. The requirement for producing and maintaining a stock inventory for a variety of machine consoles of course leads to increased costs.

A principal object of the present invention therefore is to provide a washing machine that is adapted to have a filter device mounted on the operation console or any other exterior surface thereof and, moreover, which has a universal construction whether or not the console is provided with such a filter device so as to reduce production costs.

A common deficiency of previous devices for filtering water for clothes washing machine units is the difficulty of accessibility to the device. Most of the devices are filtration units that are mounted inside the washing machine. By being mounted inside, the filtration units is not easily observable for the purpose of determining when the filter media in the device has reached the end of its useful life. In addition, replacing the filter media is difficult because either the clothes washing machine must be pulled away from the wall to gain access to the rear exterior. Therefore, there is need for a water filtration apparatus, for use with a clothes washing machine that can be readily observed to determine when the filter media is spent and that can be accessed to facilitate filter removal and replacement with a clean filter. Optimally, a need exists for an apparatus that meets these needs while occupying only a minimum amount of space.

### BRIEF SUMMARY OF THE INVENTION

The present invention addresses some of the problems identified above by providing a water filtration apparatus for mounting on the exposed exterior surfaces of a clothes washing machine. A means of mounting the apparatus onto the exterior surfaces is provided. The apparatus also includes a readily replaceable filter cartridge. Due in part to these features, the water filtration apparatus of the present invention results in improved efficiency in replacement time and required space as compared to existing devices. The inventive device also results in an apparatus that is readily observable to determine whether the filter media has reached the end of its useful life.

To enable the filter cartridge to be readily replaceable, the filter cartridge is releasably connectable, without the use of special tools, to a filter receptacle. The filter cartridge contains a material or combination of materials for removing undesired constituents from the unfiltered water. Because of the ease with which the filter cartridge of the present invention may be replaced and further because of its readily accessible location on the exterior of the clothes washing machine, the volume of filter media required may be reduced, which allows the overall size of the present invention to be smaller than existing devices. The size may also be reduced through the use of a flat filter media. Available in sheets that are less than 1/8 inches in thickness, flat water filter media may be used within the filter cartridge of the present invention to substantially reduce its overall size as compared to existing clothes washing machine water filters that employ a granular filter media in filters that are not as easily accessible.

To use the water filtration apparatus of the present invention, the consumer mounts the housing containing the filter cartridge onto the exterior surface of the clothes washing machine. An unfiltered water supply is connected to the unfiltered water inlet of the present invention. Water from the unfiltered water inlet flows to the filter receptacles and through the filter media. Filtered water exits the filter media and is supplied to the clothes washing machine through a filtered water outlet that the consumer connects to the water leads of the clothes washing machine cabinet. The clothes washing machine is thereby supplied with filtered hot and cold water to clothes washing machine's water dispenser.

Because the water filtration apparatus of the present invention is mounted on an exposed, easily accessible, and plainly visible surface of the clothes washing machine cabinet, the consumer may more readily and easily install the present inventive filter cartridge. In addition, an indicator of filter life may be provided with the present invention that is also readily observable because the apparatus is mounted on the exterior of the clothes washing machine.

These and other features, aspects and advantages of the present invention will become better understood with reference to the following description and appended claims. The accompanying drawings, which are incorporated in and constitute a part of this specification, illustrate an embodiment of the invention and, together with the description, serve to explain the principles of the invention.

### BRIEF DESCRIPTION OF THE DRAWINGS

FIG. 1 is a diagrammatic representation of an embodiment of present invention to be placed on an exposed surface of a clothes washing machine.

FIG. 2 is view of the mounting side of the invention.

FIG. 3 is a cross sectional view of the invention showing the inlet pipe, the outlet pipe, and the filter system.

### DESCRIPTION OF THE PREFERRED EMBODIMENT

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

In general, the present invention is a water filtration apparatus that is mountable on the exposed exterior surfaces of the clothes washing machine. The water filtration apparatus provides filtered water to the interior of a clothes washing machine cabinet so that filtered water is available for the clothes washing machine. By providing for the mounting of the apparatus on the exposed or visible surfaces of the clothes washing machine, installation, monitoring, and filter replacement are more readily facilitated as compared to existing devices. Filter media is contained within a filter cartridge that is readily replaceable without requiring the consumer to use special tools.

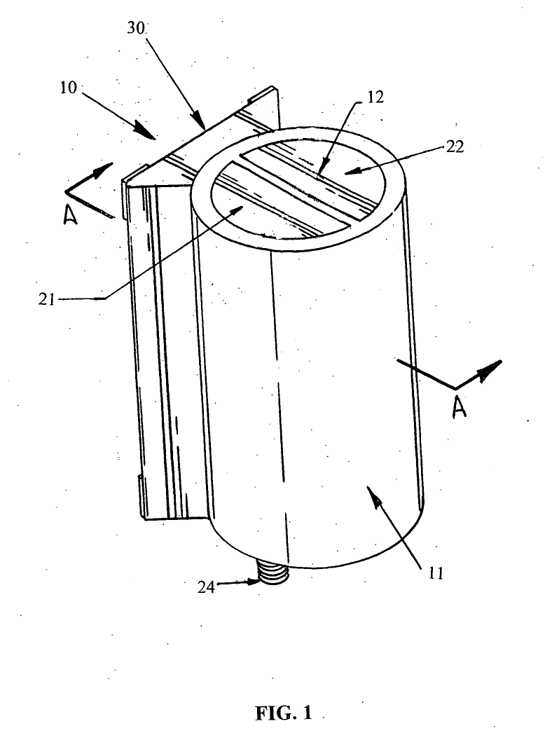

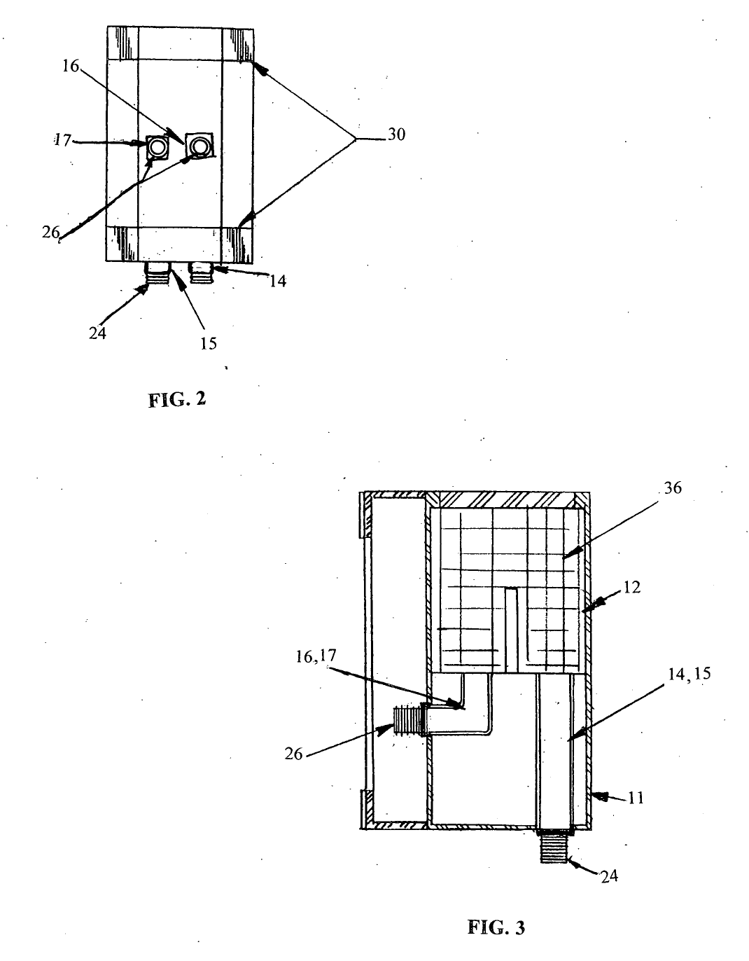

FIG. 1 and FIG. 2 illustrates a water filtration apparatus 10 having a housing 11 and a filter cartridge 12 installed into a cold water chamber 21 and into a hot water chamber 22 designed for receiving the filter cartridge 12. An unfiltered cold water supply inlet conduit 14 and an unfiltered hot water supply inlet conduit 15 for supplying unfiltered water and a filtered cold water outlet conduit 16 and a filtered hot water outlet conduit 17 for delivering filtered water to the water dispenser of a clothes washing machine (not shown) are also shown. The unfiltered cold water supply inlet conduit 14 and the unfiltered hot water supply inlet conduit 15 may consist of the flexible tubing originally connected to the rear of clothes washing machine for the supply of unfiltered water thereto. Filtered cold water outlet conduit 16 and filtered hot water outlet conduit 17 may be made from the same type of flexible plastic tubing for supplying the filtered potable water to the dispensing mechanisms. A universal inlet fitting 24 is located at the exposed end of the water supply inlet conduits 14, 15 protruding from the housing 11. A universal outlet fitting 26 is located at the exposed end of the water outlet conduits 16, 17 protruding from the housing 11.

After installation, unfiltered water enters the housing 11 of water filtration apparatus 10 through the unfiltered cold water supply inlet conduit 14 to the cold water chamber 21 and through the unfiltered hot water supply inlet conduit 15 to the hot water chamber 22. Under the water pressure generally made available for supply to the dispensing units of clothes washing machine, unfiltered water flows through filter cartridge 12 where the filter media housed within the filter cartridge 12 removes undesired constituents. Filtered water then exits the respective cold water chamber 21 and hot water chamber within housing 11 of water filtration apparatus 10 by the filtered cold water outlet conduit 16 and the filtered hot water outlet conduit 17. Filtered water is then provided to the interior of the clothes washing machine interior.

As shown in FIG. 2, the present inventive water filtration apparatus 10 is mounted on the exterior of surface of a clothes washing machine. Such location allows the consumer to readily access the apparatus for replacement of the filter cartridge 12, observe the filter media, or observe an indicator that may be provided with the apparatus for notifying the consumer to replace a used filter media with a new filter media after a certain passage of time or uses. Exterior mounting also makes installation of the filter easier upon the consumer because a separate location away from the clothes washing machine for mounting the filter is not required and complex structural modification to the rear or exterior of the clothes washing machine are not necessary.

The housing 11 of the apparatus may be provided with a magnetic attachment 30 or other affixable device such as, but not limited to adhesive, mounting bracket and fasteners, or machine screws, for temporarily or permanently affixing the water filtration apparatus 10 to the exterior of the clothes washing machine. A surface of housing 111 could contain a strip of adhesive for more adhesively mounting the water filtration apparatus onto the surface of the clothes washing machine's exposed exterior. Such an adhesive mounting means would not make permanent changes on the clothes washing machine's exterior and would not require the consumer to use special tools during installation of the apparatus. In another embodiment, the housing 11 of the apparatus may be even provided with a magnetized mounting strip 30. A magnetized mounting strip 30 would allow the consumer to change the location of the water filtration apparatus 10 as desired without permanent changes to the clothes washing machine exterior or the use of special tools. These are only a few examples of the mounting means for locating the water filtration apparatus 10 on the exterior of a clothes washing machine; other mounting means can be readily envisioned by one skilled in the art using the teachings of this disclosure. The only requirement is that the apparatus 10 be mounted to an exterior surface of the clothes washing machine that is easily accessible and easily visible to allow for ready replacement of the filter cartridge and viewing of any indicator means on the apparatus.

Various indicator devices may be incorporated into the apparatus so that one may quickly determine whether the filter media has reached its useful life. For example, color indicators, gauge-type indicators, flow rate indicators, electronic indicators and the like may be utilized. It is to be understood that the present invention is not limited to the particular type of indicator that may be employed. The aspects of the present invention allow the user to quickly and easily determine whether the filter media is spent by merely observing the exterior-mounted and unobstructed apparatus.

FIG. 3 shows the presently inventive water filtration apparatus 10 as a cross sectional detail. As in the device shown in FIG. 1 and FIG. 2, water filtration apparatus 10 includes an unfiltered cold water supply inlet conduit 14 is connected to a conduit for supplying unfiltered cold water to the cold water chamber 21 fitted with a filter cartridge 12. Likewise, an identical unfiltered hot water supply inlet conduit 15 is connected to a conduit for supplying hot water to the hot water chamber 22 fitted with a filter cartridge 12. The filter cartridge is placed into the cold water chamber 21 and the hot water chamber 22 defined by housing 11. The filter cartridge 12 is connected to the inlet conduit 14, 15 for supplying unfiltered water by a releasably connectable unfiltered water inlet fitting 24. The filter cartridge is also connected to the outlet conduit 16, 17 for transporting filtered water away from the chambers 21, 22 by a releasably connectable filtered water outlet fitting 26.

Unfiltered water is provided to unfiltered water supply inlet conduit 14, 15 by connecting the conduit to a main unfiltered water supply (not shown) using a universal fitting 24. A mounting means 30 (such as the machine screw holes shown or an adhesive strip or magnetic strip, etc.) is located on the rear of housing 11 for securing the water filtration apparatus 10 to the exposed surface of the clothes washing machine.

Upon placing a filter cartridge 12 into the chambers 21, 22, and providing unfiltered water, the filter media 36 contained within filter cartridge 12 of water filtration apparatus 10 removes unwanted constituents from the unfiltered water as follows. Unfiltered water flows from main unfiltered water supply, through fitting 24, and into unfiltered water supply inlet conduit 14, 15. Flowing through unfiltered water supply inlet conduit 14, 15, the unfiltered water enters housing 11 and into the chambers 21, 22. Unfiltered water then flows to through the filter cartridge 12 where unwanted constituents are then removed by the filter media 36 as the water flows through the filter media 36 held within filter cartridge 12. Filtered water exits filter cartridge 12 though the filtered water outlet conduit 16, 17 and flows away from the chambers 21, 22 through the outlet fitting 26 and into the interior of the clothes washing machine.

To replace the filter media, the consumer simply removes filter cartridge 12 from the chambers 21, 22 located in housing 11. An indicator may be provided for notifying or reminding the consumer to replace the filter cartridge 12. By providing a water filtration apparatus that is mountable upon the exterior surfaces of the clothes washing machine, the consumer may place the apparatus anywhere on the top, sides, or front of the clothes washing machine. Because the water filtration apparatus may be so located, the consumer can quickly and easily install the apparatus, change the filter cartridge, or monitor an indicator on the filter cartridge to determine if the replacement time is near. Existing devices, installed upon the rear of the clothes washing machine, the interior of the clothes washing machine, or within the shell of the clothes washing machine are more difficult to access. Accordingly, the consumer's efforts to install, monitor, or replace the filter media of existing devices is frustrated.

The filter media 36 located in filter cartridge 12 may be any material or combination of materials that removes undesired constituents from the unfiltered water. By way of example only, the filter media 36 may include activated carbon, which may remove sediment, chlorine, certain metal ions, organics, and other constituents that may pose a cause an undesirable smell or residue on clothing. The filter media 36 may contain more than one active material—such as activated carbon in conjunction with charge-modified filter media, such as charge-modified meltblown or microfiber glass webs.

Because the filter cartridge 12 of the present invention is readily accessible and therefore readily replaceable, the volume of filter media 36 required for filtration may be reduced. Rather than extending the interval between replacement times by using relatively large quantities of inaccessible and inconvenient filter media, the present invention allows for easy replacement of a filter cartridge and therefore requires less filter media than used in existing devices. Accordingly, if the filter media 36 is a granular material such as granular activated charcoal, the filter cartridge 12 of the present invention may be smaller than existing devices because it can be more readily replaced more often.

The use of a flat filter media 36 within the filter cartridge 12 also allows the filter media, and therefore the filter cartridge 12, of the present invention to be smaller than existing devices. A flat filter media can be constructed from any material capable of removing the particular unwanted constituents from the unfiltered water supply. Furthermore, the flat filter media may consist of a laminate of filter media where different layers remove different constituents or support the filter media. Laminated filter media includes a layer of activated carbon contained between two sheets of support material may be utilized to form relatively flat sheets. In addition, while a cylindrical-shaped filter cartridge is depicted in FIG. 1 and FIG. 2, any shape may be used depending upon what is aesthetically pleasing to the consumer.

A universal clothes washing machine water supply hose (not shown) is releasably connected to the unfiltered water inlet fitting 24 affixed to the inlet conduits 14, 15. As used in the present application, connectable means allow the unfiltered water supply inlet conduits 14, 15 to be connected and disconnected repeatedly with a connection via the universal inlet fitting 24 and filtered water outlet conduits 16, 17 to be connected and disconnected repeatedly with a connection via the universal outlet fitting 26 that prevents water leakage and does not require any permanent physical alterations to the apparatus. For example, the fittings 24, 26 can be made of plastic or brass male to female connectors with ferrules capable of sealing the supply hose to the conduits 14, 15, 16, 17. This allows for the easy installation of the water filtration apparatus. Furthermore, once the apparatus is mounted on the clothes washing machine by the consumer, disconnecting the unfiltered water supply inlet conduits 14, 15 and filtered water outlet conduits 16, 17 is not required for changing the filter cartridge. Other types of sealable connections such as slip-on connectors, brass male/female connectors with ferrules, O-rings, etc., may also be utilized.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both in whole or in part. Therefore, the spirit and scope of the claims should not be limited to the description of the preferred versions contained therein.

1. A water filtration apparatus for a clothes washing machine, said apparatus comprising:
a housing defining a dual filtering chamber comprising a cold water filter chamber and a hot water filter chamber for receiving a replaceable filter cartridge, said housing having an unfiltered cold water inlet, an unfiltered hot water inlet, a filtered cold water outlet, and a filtered hot water outlet;
said unfiltered cold water inlet and said unfiltered hot water inlet being connectable to a conduit for supplying unfiltered water to said cold and hot water chambers and said filtered cold water outlet and said filtered hot water outlet being connectable to a conduit for transporting filtered water away from said chambers;
said filter cartridge comprising a filter media and being releasably insertable into said chambers.

2. The water filtration apparatus of claim 1, wherein a mounting means located upon said housing for mounting said water filtration apparatus to a surface of a clothes washing machine.

3. The water filtration apparatus of claim 1, wherein the water filter media comprises activated carbon.

4. The water filtration apparatus of claim 3, wherein said filter media comprises a flat water filter media.

5. The water filtration apparatus of claim 1, further comprising a first flexible hose releasably connected to said unfiltered cold water inlet, a second flexible hose releasably connected to said unfiltered hot water inlet.

6. The water filtration apparatus of claim 1, further comprising a first collapsible hose releasably connected to said unfiltered cold water inlet, a second collapsible hose releasably connected to said unfiltered hot water inlet, a third collapsible hose releasably connected to said filtered cold water outlet, and a fourth collapsible hose releasably connected to said filtered hot water outlet.

7. A clothes washing machine comprising the water filtration apparatus of claim 1 mounted on an exposed exterior surface of said clothes washing machine, said water filtration apparatus being connected so that filtered water is supplied thereto.

8. The water filtration apparatus of claim 7, wherein the mounting means attached to said housing for mounting said housing to an exposed exterior surface of a clothes washing machine is a magnet attached to said housing.

9. The water filtration apparatus of claim 7, wherein the mounting means attached to said housing for mounting said housing to an exposed exterior surface of a clothes washing machine is an adhesive tape attached to said housing.

10. The water filtration apparatus of claim 7, wherein the mounting means attached to said housing for mounting said housing to an exposed exterior surface of a clothes washing machine are screws for attaching said housing to said clothes washing machine surface.

11. A water filtration apparatus for mounting on the exposed exterior surfaces of a clothes washing machine, said apparatus comprising:
a housing defining a receptacle for receiving a filter cartridge, said housing having an unfiltered cold water inlet, an unfiltered hot water inlet, a filtered cold water outlet, and a filtered hot water outlet;
said unfiltered cold water inlet being connectable to a first conduit for supplying unfiltered cold water to said receptacle, said unfiltered hot water inlet being connectable to a second conduit for supplying unfiltered hot water to said receptacle, said filtered cold water outlet being connectable to a third conduit for transporting filtered cold water away from said receptacle, and said filtered hot water outlet being connectable to a fourth conduit for transporting filtered hot water away from said receptacle;
said receptacle comprising a hot water chamber and a cold water chamber;
said filter cartridge comprising a flat water filter media comprising activated carbon and being releasably connectable to said receptacle through an unfiltered cold water inlet port, an unfiltered hot water inlet port, a filtered cold water outlet port, and a filtered hot water outlet port;

12. The water filtration apparatus of claim 11 wherein a flat water filter media comprises a laminate of filter media.

13. A clothes washing machine comprising the water filtration apparatus of claim 111 mounted on an exposed exterior surface of said clothes washing machine, said water filtration apparatus being connected to said clothes washing machine that filtered potable water is supplied thereto.
